(19) United States
(12) Patent Application Publication
(10) Pub. No.: US 2012/0069752 A1
(43) Pub. Date: Mar. 22, 2012

(54) METHOD AND SYSTEM FOR GENERATING A MOBILE DEVICE NETWORK FOOTPRINT INDEX

(75) Inventors: Audry LAROCQUE, Mont-Royal (CA); Nicolas CARRE, Montreal (CA); Éric Mélin, Montreal (CA)

(73) Assignee: NEURALITIC SYSTEMS, Montreal (CA)

(21) Appl. No.: 13/158,398

(22) Filed: Jun. 11, 2011

Related U.S. Application Data
(60) Provisional application No. 61/353,796, filed on Jun. 11, 2010.

(51) Int. Cl. H04W 24/00

(52) U.S. Cl. 370/252

(57) ABSTRACT

The present relates to a method and a system for generating a mobile device network footprint index. The method and system receives, at an analytic system, information related to a network footprint of mobile devices. This information consists in records representative of mobile IP sessions occurring on a mobile IP network. Then, the method and system aggregates, by means of the analytic system, the information by models of mobile devices; and processes, by means of the analytic system, the aggregated information to calculate at least one metric representative of a network footprint of a selected model of mobile device over a selected period of time. A mobile device network footprint index is generated, by means of the analytic system, by calculating the at least one metric for several selected models of mobile devices over the selected period of time.

### BRIEF DESCRIPTION OF THE DRAWINGS

In the appended drawings:

FIG. 1 illustrates a system for generating a mobile device network footprint index, according to a non-restrictive illustrative embodiment;

FIG. 2 illustrates a method for generating a mobile device network footprint index, according to a non-restrictive illustrative embodiment;

FIG. 3 illustrates a network footprint of a first category of mobile devices, according to a non-restrictive illustrative embodiment;

FIG. 4 illustrates a network footprint of a second category of mobile devices, according to a non-restrictive illustrative embodiment;

FIG. 5 illustrates a network footprint of a third category of mobile devices, according to a non-restrictive illustrative embodiment;

FIG. 6 illustrates a report representing a network footprint index for several models of mobile devices, according to a non-restrictive illustrative embodiment.

### DETAILED DESCRIPTION

Nowadays, the data traffic on mobile IP networks is increasing at a steady rate. This is due to a combination of factors, including the availability of mobile devices with advanced capabilities like smart phones, the variety of applications and mobile IP services available to the end users, and the variety of usage patterns of these end users when consuming mobile IP services.

This regular increase in mobile data traffic is an opportunity for mobile network Operators, but also an issue. Some consequences for the mobile network Operators include: the need to regularly upgrade the mobile IP network infrastructure to support the data traffic explosion, the necessity to adapt the pricing models to compensate for the cost of the extension of the mobile IP network infrastructure, or the controversial traffic shaping/policing approach to manage the most data hungry subscribers and/or applications (e.g. peer to peer, video streaming).

One particular characteristic of the increase in mobile data traffic is that it does not only apply to user traffic (the traffic directly related to the applications used by the end users), but also to the associated control traffic (the traffic generated by the interactions of the mobile devices with the mobile IP network infrastructure, to support the delivery of mobile IP services). Furthermore, the amount of control traffic generated by mobile devices varies significantly from one model to another, for the same amount of supported user traffic. Thus, each model of mobile device may be characterized by a network footprint, to estimate the amount of control traffic generated for a given amount of user traffic. This network footprint is used as an indicator of the efficiency of a specific model of mobile device. However, a mobile network Operator is currently not capable of generating such a network footprint for at least a subset of all the models of mobile devices operating on its mobile IP network.

Thus, there is a need of overcoming the above discussed limitations concerning the lack of availability of an evaluation of the network footprint of various models of mobile devices operating on a mobile IP network. An object of the present method and system is therefore to generate a mobile device network footprint index.

In a general embodiment, the present method is adapted for generating a mobile device network footprint index. For doing so, the method receives, at an analytic system, information related to a network footprint of mobile devices. Then, the method aggregates, by means of the analytic system, the information by models of mobile devices; and processes, by means of the analytic system, the aggregated information to calculate at least one metric representative of a network footprint of a selected model of mobile device over a selected period of time. Additionally, the method generates a mobile device network footprint index, by means of the analytic system, by calculating the at least one metric for several selected models of mobile devices over the selected period of time.

In another general embodiment, the present system is adapted for generating a mobile device network footprint index. For doing so, the system comprises an analytic system for receiving information related to a network footprint of mobile devices, for aggregating the information by models of mobile devices, and for processing the aggregated information to calculate at least one metric representative of a network footprint of a selected model of mobile device over a selected period of time. Additionally, the system generates a mobile device network footprint index by means of the analytic system, by calculating the at least one metric for several selected models of mobile devices over the selected period of time.

In one specific aspect of the present system, the analytic system includes a processing unit for aggregating the information and processing the aggregated information, and a database for memorizing the aggregated information.

In another specific aspect of the present method and system, the information related to a network footprint of mobile devices consists in records representative of the mobile IP sessions occurring on a mobile IP network, the records comprising for each mobile IP session: timestamps of occurrence of the mobile IP session, an identifier of a mobile device used for the mobile IP session, and at least one measure representative of the network footprint of the mobile device.

In still another specific aspect of the present method and system, each measure representative of the network footprint is either a measure representative of an user traffic, or a measure representative of a control traffic.

One illustrative metric of the network footprint is a ratio between a volume of control traffic and a volume of user traffic. Another illustrative metric is a ratio between a number of control messages and a volume of user traffic. In one illustrative use case, the control traffic taken into consideration is related to interactions of the mobile devices with the mobile IP network infrastructure (in this case, the user traffic taken into consideration is the global user traffic, including all types of applications and mobile IP services). In another illustrative use case, the control traffic taken into consideration is generated by a specific type of application or mobile IP service (in this case, the user traffic taken into consideration is the user traffic generated by this specific type of application or mobile IP service).

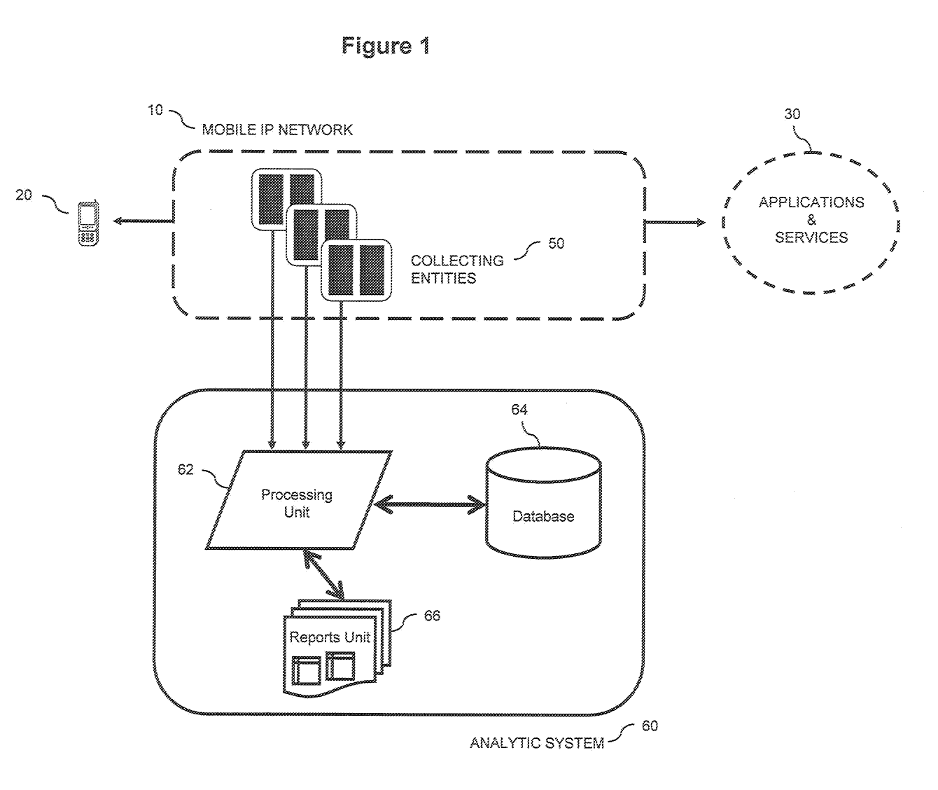

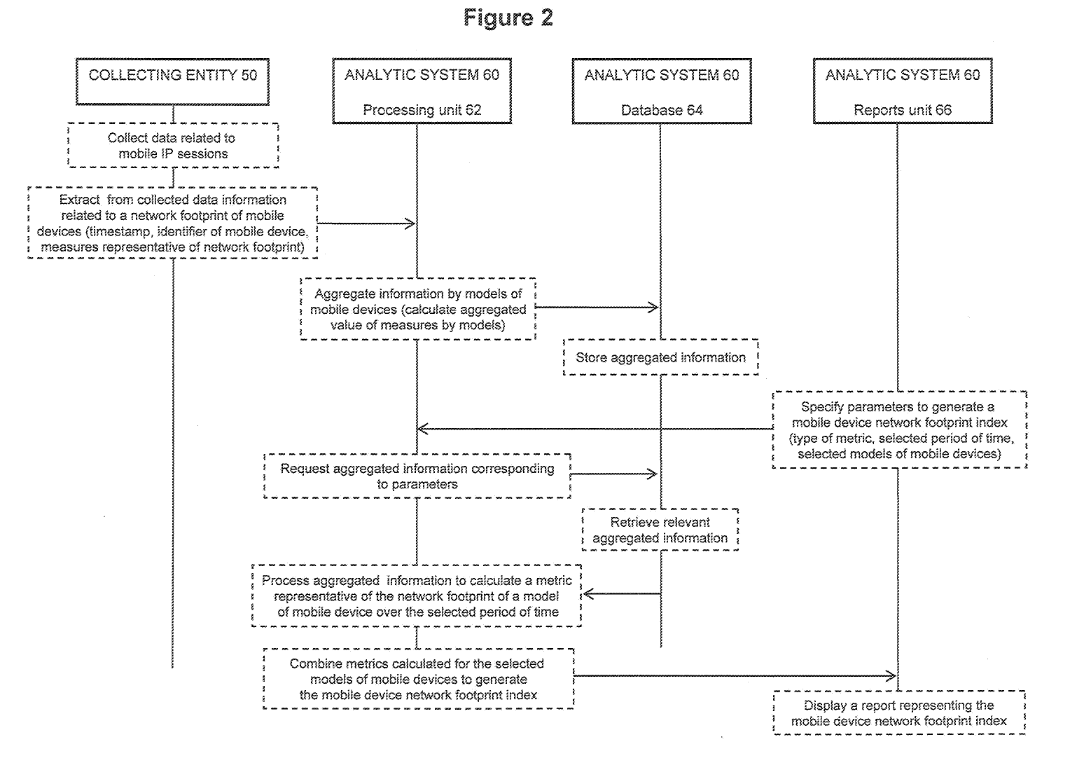

Now referring concurrently to FIGS. 1 and 2, a method and system for generating a mobile device network footprint index will be described.

A mobile IP network 10 is represented in FIG. 1. It allows mobile devices 20 to access IP based applications and services 30, via the mobile IP network 10. For this purpose, mobile IP traffic is generated between the mobile devices 20 and the infrastructure supporting the IP based applications and services 30. The role of a collecting entity 50 is to collect data related to this mobile IP traffic.

The present method and system is applicable to any type of mobile IP network, including without limitation: General Packet Radio Service (GPRS), Universal Mobile Telecommunication System (UMTS) network, Long Term Evolution (LTE) network, Code Division Multiple Access (CDMA) network, or Worldwide Interoperability for Microwave Access (WIMAX) network.

The collecting entities 50 may operate in two ways. In a first embodiment, the collecting entities capture in real time IP packets from the mobile IP traffic occurring on a specific segment of the mobile IP network 10. The captured IP packets contain data related to mobile IP sessions occurring on the mobile IP network. A mobile IP session is defined as an IP based data session, initiated by a mobile device 20 on the mobile IP network 10, during which the mobile device 20 consumes various types of applications and services 30 (for example messaging, web browsing, social networking, multimedia streaming, etc). The IP packets related to a specific mobile IP session are analyzed according to several protocol layers (generally network, transport, and applicative layers) of the Open System Interconnection (OSI) model, in order to extract information relevant for the calculation of metrics representative of a network footprint. This process is well known in the art as Deep Packet Inspection (DPI).

Each mobile IP session is associated to its corresponding mobile device 20. An identifier of the mobile device is present in specific IP packets related to the mobile IP session, and is extracted. Thus, all the information extracted from the mobile IP sessions is correlated to the identifier of the corresponding mobile device. In most cases, this identifier of the mobile device is unique, and thus allows a unique identification of the mobile device over time. For instance, in the case of an UMTS network with collecting entities deployed on the Gn interface between the Serving GPRS Support Node (SGSN) and the Gateway GPRS Support Node (GGSN), a unique identifier of a mobile device 20 is the International Mobile Equipment Identity (IMEI), which is extracted from IP packets of the GPRS Tunneling Protocol (GTP) control plane.

The IP packets related to a specific mobile IP session, captured in real time by the collecting entities 50, are divided in two categories. Some IP packets consist in the user traffic. They are directly related to the applications and services 30 consumed by a mobile device 20. And some IP packets consist in the control traffic. They are related to the interactions of a mobile device 20 with the mobile IP network infrastructure, to establish/manage/release the mobile IP sessions. Information is extracted from both the user traffic and the control traffic. For instance, the types of applications used during a mobile IP session, and the associated volumes of user traffic, illustrate information related to the user traffic. The IMEI of a mobile device engaged in a mobile IP session and the associated volume of control traffic generated by the interactions with the mobile IP network infrastructure, illustrate information related to the control traffic.

Additionally, timestamps (e.g. beginning and end) of the occurrence of each mobile IP session are appended to the list of extracted information.

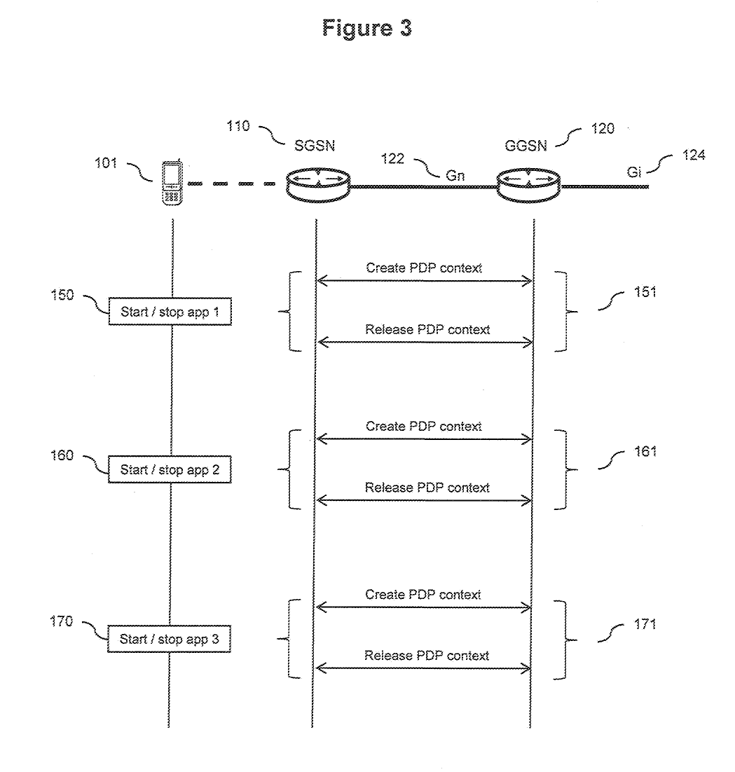

More details will be given later (in relation to FIGS. 3, 4, and 5), to illustrate the notions of user traffic and control traffic, in the case of an UMTS network. Moreover, it will be explained how the notion of control traffic is also applicable to IP packets directly related to an application (not only to the interactions of the mobile devices with the mobile IP network infrastructure).

In an alternative embodiment, the collecting entities 50 do not operate on the real time mobile IP traffic, but collect data that have been gathered by one or several equipments of the mobile IP network infrastructure. The gathered data usually consist in logs of the mobile IP sessions. The same type of information is extracted from these gathered data, as in the case of the previously described first embodiment. However, the granularity of the information may be lower in this second embodiment, since the collecting entities 50 only extract the subset of information present in the gathered data, and some useful information may be missing. However, the extracted information is generally sufficient to generate metrics representative of a network footprint, since they generally include for each mobile IP session, at least: timestamps of occurrence of the mobile IP session, an identifier of the mobile device used for the mobile IP session, and several measures representative of the network footprint of the mobile device (for instance, the volumes of user traffic and control traffic).

In the case of an UMTS network, such data (used for the generation of the network footprint of mobile devices in the context of the present method and system) are gathered mainly by the GGSN, and potentially also by the SGSN. These data are referred to as Call Detail Records (CDRs). They include detailed information related to the mobile IP sessions, as mentioned previously (timestamps, identifier of the mobile devices, several measures). Thus, the collecting entities 50 retrieve the CDRs from the GGSN (and from the SGSN if applicable), and extract the relevant information from the CDRs, in order to gather information representative of a network footprint of the mobile devices.

The collecting entities 50 transmit the information extracted from the data related to the mobile IP sessions to an analytic system 60. In one embodiment of the present method and system, the analytic system 60 is composed of a processing unit 62, a database 64, and a reports unit 66.

The network footprint of a mobile device consists in one or several metrics computed by the processing unit 62. Several examples of metrics will be given later, in relation to FIGS. 3, 4, and 5. The computation is performed in two steps.

In a first step, the information received from the collecting entities 50 is aggregated by models of mobile devices, by the processing unit 62. The aggregated information is stored in the database 64, indexed by the models of mobile devices. The information received from the collecting entities 50 contains measures representative of the network footprint of the mobile devices 20. The aggregation of the information consists in calculating aggregated values of these measures (stored in the database 64) per models of mobile devices, which are further processed in a second step to compute the metrics representative of a network footprint of mobile devices.

Examples of the measures (representative of the network footprint of mobile devices) present in the records transmitted by the collecting entities 50, and aggregated by the processing unit 62 include: the volume of user traffic generated by the global user traffic (all applications and mobile IP services included), the volume of user traffic generated by a specific type of application or mobile IP service, the volume of control traffic/the number of control messages generated by the interactions of the mobile devices with the mobile IP network infrastructure, the volume of control traffic/the number of control messages generated by a specific type of application or mobile IP service.

In the case of a volume of traffic, based on a specific implementation of the present method and system, several layers (according to the OSI model) of the IP packets may be taken into consideration. For instance, one or a combination of: the transport, the network, and the applicative layers.

For illustration purposes, we consider the calculation of one aggregated measure: the aggregated volume of user traffic generated by the global user traffic, for a specific model of mobile device, over a specific period of time. Several periods of time are considered: days, weeks, months. This provides a greater flexibility in the computation (in the second step) of the metrics based on the aggregated volume of user traffic generated by the global user traffic. For instance, to calculate a metric based on the volume of user traffic generated by the global user traffic over several selected consecutive months, the aggregated volume of user traffic generated by the global user traffic for each of the selected month is simply added.

The collecting entities 50 generate records representative of the mobile IP sessions occurring on the mobile IP network, which are transmitted to the analytic system 60. Such a record representative of a mobile IP session includes: timestamps (e.g. beginning and end) of occurrence of the mobile IP session, an identifier of the mobile device used for the mobile IP session, and at least one measure representative of the network footprint of the mobile device. For instance, such at least one measure representative of the network footprint of the mobile device includes the aforementioned volume of user traffic generated by the global user traffic.

The maximum duration associated to a record (represented by the timestamps) is selected to facilitate the aggregation of the measures over specific periods of time (e.g. days, weeks, and month). For example, a mobile IP session longer than one hour is represented by several records with a maximum duration of one hour, with timestamps boundaries (beginning and/or end) aligned with fixed hours when possible.

A record is processed as follows. The identifier of the mobile device is used to determine the model of the mobile device. In the most favorable case, the model of the mobile device is directly inferred from the identifier of the mobile device. For instance, if the identifier is the IMEI of the mobile device (as previously mentioned in the case of an UMTS network), a portion of the IMEI contains the model of the mobile device. In a less favorable case, the model of the mobile device cannot be directly inferred from the identifier of the mobile device. An external source of information (e.g. a database with subscribers' information—not represented in FIG. 1) is used to perform the mapping between the identifier of a mobile device in a record, and the corresponding model of the mobile device. Then, the volume of user traffic (taken as an example of a measure representative of the network footprint) generated by the global user traffic from the considered record is aggregated to several measures of the volume of global user traffic stored in the database; in relation to the specific model of mobile device, and taking into consideration the timestamps of the record. This step involves the following interactions with the database 64: retrieving the relevant measures of the volume of global user traffic from the database (for the specific model of mobile device), performing the aggregation of the volume of user traffic in the record with these relevant measures, and storing the resulting aggregated measures in the database 64. The timestamps of beginning and end of the record allow the selection of the relevant measures of the volume of global user traffic in the database. Several aggregated measures with a granularity in months, weeks, days, and potentially hours, are usually memorized in the database 64. As already mentioned, the timestamps of the records typically cover a period of one (or even less) to several hours. For instance, a record with a coverage of one hour is used to generate daily, weekly, and monthly, aggregated measures; stored in the database 64. This example illustrates the processing of the records by the processing unit 62, and may be extended to any type of measure representative of the network footprint and present in the records.

The notion of model of mobile device is the one well known in the art. A manufacturer of mobile devices generally manufactures a portfolio of various models of mobile devices. Each model has specific properties, and is uniquely identified as a particular model.

In a second step, the processing unit 62 generates the network footprint of a selected model of mobile device over a selected period of time. For this purpose, one or several metrics representative of the network footprint are calculated. The relevant aggregated measures, corresponding to the selected model of mobile device and the selected period of time, are requested from the database 64, and used to calculate the metrics. For instance, a metric representative of the network footprint is the ratio of the volume of control traffic generated by the global control traffic (interactions of the mobile devices with the mobile IP network infrastructure) and the volume of user traffic generated by the global user traffic (all types of applications and mobile IP services are taken into consideration). The aggregated volume of control traffic generated by the global control traffic and the aggregated volume of user traffic generated by the global user traffic, for the selected model of mobile device and the selected period of time, are retrieved from the database. Then, the metric is generated by computing the ratio between the two aggregated volumes of traffic

In some cases, the selected period of time for the calculation of the metric does not correspond to the periods of aggregation in the database 64. For example, the selected period of time is two consecutive weeks, and the periods of aggregation in the database 64 are days, weeks, and months. In this case, the aggregated measures for the two weeks corresponding to the selected period of two consecutive weeks are retrieved from the database 64, and cumulated, to generate the underlying metrics.

A network footprint index is generated (by the processing unit 62) by calculating a selected type of metric representative of the network footprint of several selected models of mobile devices over a selected period of time. The index is then presented to end users (e.g. staff members of the mobile network Operator) in the form of a report, via a Graphical User Interface, on the reports unit 66. A report represents the combination of one (or several) metric(s), for a selected group of models of mobile devices, over a selected period of time. Each report illustrates an aspect of the network footprint index, and enables the comparison of the network footprint of several models of mobiles devices, from a specific perspective (the specific metric(s) selected for the report, and the specific period of time selected to compute the metric(s)).

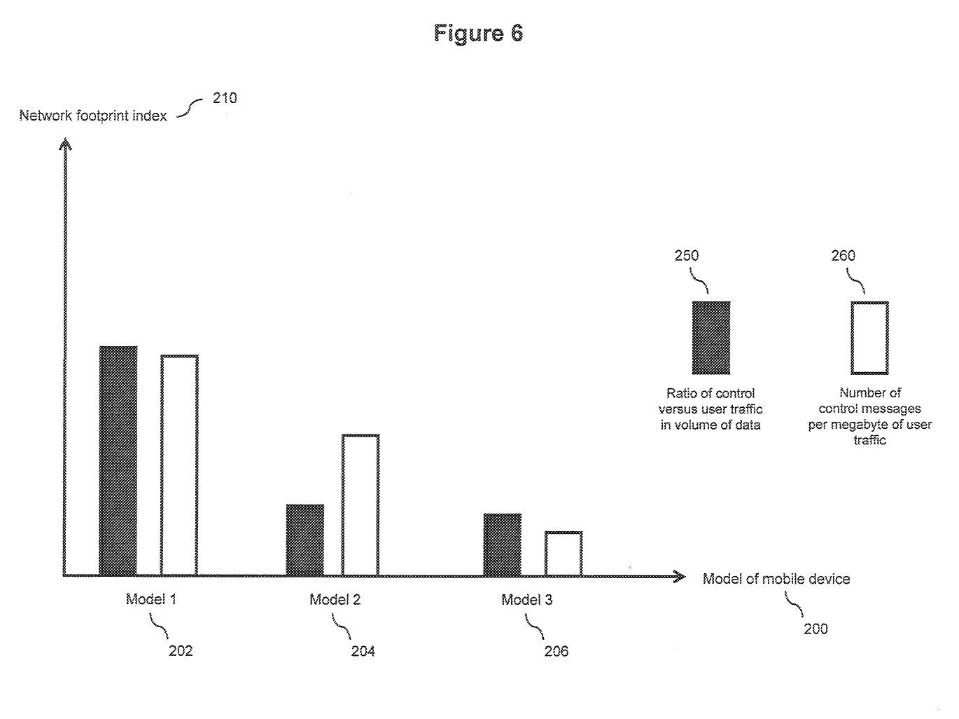

The details of the interactions between the reports unit 66 and the processing unit 62 will be further detailed later, in relation to the description of FIG. 6.

Now referring concurrently to FIGS. 3, 4 and 5, a network footprint of different categories of mobile devices will be described.

The goal of FIGS. 3, 4 and 5 is to illustrate a case, where different models of mobile devices have a significantly different network footprint.

For this purpose, we consider a mobile network based on the UMTS technology. A SGSN 110 and a GGSN 120 are represented. The user traffic generated by the mobile devices 101, 102, and 103, transits via the Gn interface 122, which is a logical representation of the IP link between the SGSN 110 and the GGSN 120. The Radio Access Network (RAN) between the mobile devices (101, 102, and 103) and the SGSN 110 is not represented in FIG. 1 for simplification purposes.

The user traffic between the SGSN 110 and the GGSN 120 is encapsulated in GPRS Tunneling Protocol (GTP) tunnels. The user plane of GTP transports the user traffic, and the control plane of GTP establishes/manages/releases the GTP tunnels. Each GTP tunnel is represented by a logical entity: the Packet Data Protocol (PDP) context.

In order to be able to send/receive data, a mobile device (101, 102, and 103) requests the establishment of a PDP context. GTP control messages are exchanged between the SGSN 110 and the GGSN 120, to manage the PDP context(s) associated to a mobile device: create PDP context, update PDP context, release PDP context. A PDP context is related to a unique mobile device. However, a mobile device may establish several PDP contexts, to support different types of mobile IP services. For instance, a PDP context is used for Multimedia Messaging Service (MMS), a PDP context is used for Internet access, and a PDP context is used for IP Multimedia Subsystem (IMS) services. The type of mobile IP service(s) associated to a PDP context is referred to as the Access Point Name (APN).

A PDP context is defined by: the mobile device it is associated with, an APN (the type of mobile IP service(s) it supports), an IP address allocated to the mobile device for sending/receiving data related to the mobile IP service(s) supported by the PDP context (each primary PDP context may have a different IP address—a secondary PDP context has the same IP address as the primary PDP context it refers to), and a Quality of Service (QoS) profile. Additional parameters related to a PDP context are not mentioned for simplification purposes. Up to 11 PDP contexts (primary and secondary) may be established by a single mobile device, according to the current UMTS specifications. However, the effective number of PDP contexts which may be established (primary and secondary) depends on the mobile IP network infrastructure, and on the capabilities of each model of mobile device. Thus, the effective number may be significantly lower.

The management of the PDP contexts from the mobile devices perspective is constrained by the policy imposed by the mobile network Operator owning the mobile IP network infrastructure. For instance, mobile IP services are bound to specific APNs defined by the mobile network Operator. Thus, using a specific type of mobile IP service bound to a specific APN triggers the creation/update of a specific PDP context. However, taking into account these constraints, each model of mobile device still behaves differently.

For example, mobile network Operators may define a specific APN for the MMS service. Thus, most models of mobile devices behave similarly: open a dedicated PDP context to use the MMS service. However, in case a PDP context is already established for Internet access, some models of mobile devices may be able to maintain this Internet PDP context, while establishing the MMS PDP context, then performing the MMS operations, and finally releasing the MMS PDP context. But other models of mobile devices may need to release the Internet PDP context, create the MMS PDP context, perform the MMS operations, then release the MMS PDP context, and finally re-create the Internet PDP context. This second procedure generates more control traffic for the same amount of user traffic. Alternatively, some models of mobile devices may re-use an existing Internet PDP context for the MMS traffic, avoiding the creation of a dedicated MMS PDP context, and thus generating even less control traffic for the same amount of user traffic.

Regarding Internet PDP contexts, the behavior of various models of mobile devices also varies in great proportions. First of all, an Internet PDP context is defined as a PDP context supporting mobile IP services provided via the Internet, by opposition to mobile IP services provisioned via the mobile IP network infrastructure (like MMS or access to IMS services). Thus, an Internet PDP context supports, for example, the following mobile Internet services: web browsing, multimedia streaming from an Internet source, applications interacting with a server located on the Internet, etc.

We now consider a first category of mobile devices, which support a single mobile IP application at a time (mono task) over a dedicated Internet PDP context. Within this mono task category, some models of mobile devices may create/release the PDP contexts at each application launch. This behavior is illustrated in FIG. 3: the mobile device 101 starts a first application 150 and a PDP context is created 151; when the first application is stopped 150, the PDP context is released 151. Then, the mobile device 101 starts a second application 160 and a PDP context is created 161; when the second application is stopped 160, the PDP context is released 161. Finally, the mobile device 101 starts a third application 170 and a PDP context is created 171; when the third application is stopped 170, the PDP context is released 171.

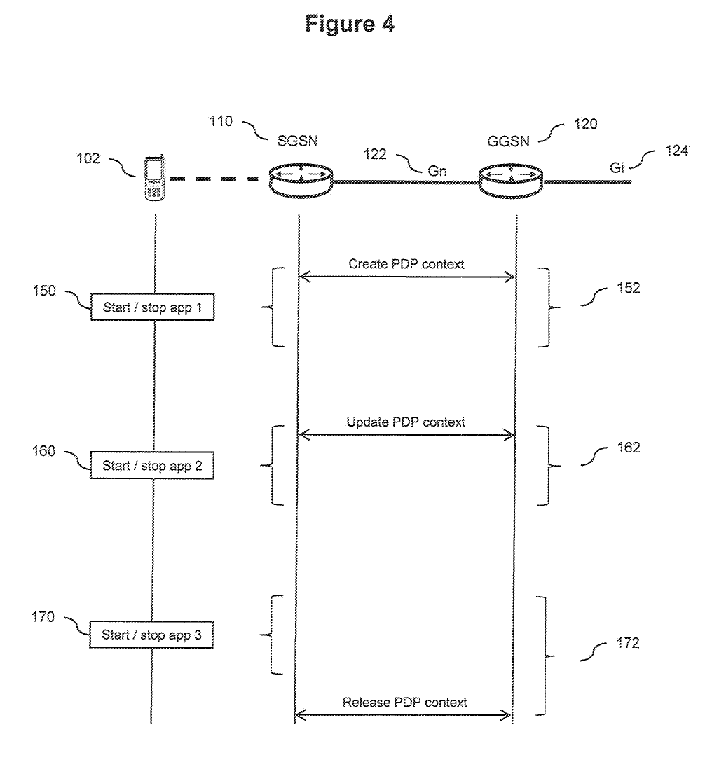

Within the mono task category, other models of mobile devices may reuse (when applicable) an existing PDP context at each application launch. This behavior is illustrated in FIG. 4: the mobile device 102 starts a first application 150 and a PDP context is created 152; when the first application is stopped 150, the PDP context is not released 152. Then, the mobile device 102 starts a second application 160 and the PDP context created for the first application is updated 162 (for instance to adapt the QoS parameters of the PDP context to the second application characteristics); when the second application is stopped 160, the PDP context is not released 162. Finally, the mobile device 102 starts a third application 170 and the PDP context updated for the second application is used without modifications 172; when the third application is stopped 170, the PDP context is released 172 (after a pre-defined amount of time without a new application launch). The update of the PDP context 162 is optional; in the most favorable case, only a creation of PDP context 152 and a release of PDP context 172 occur.

The behavior of the models of mono task mobile devices described in FIG. 4 is more efficient than the behavior of those described in FIG. 3: the amount of control traffic related to PDP context management is less important, leading to a better network footprint.

We now consider a second category of mobile devices which support multiple mobile IP applications at a time (multi task), over multiple Internet PDP contexts. Within this multi task category, some models of mobile devices may create a new PDP context at each application launch. This behavior is illustrated in FIG. 3, and has already been described for mono task models of mobile devices. The only difference is that the three applications are now running in parallel on the mobile device 101. Each time an application is started (150, 160, 170) on the mobile device 101, a new PDP context is created (151, 161, 171); unless all available PDP contexts have already been consumed (a maximum of 11 is theoretically available), in which case the application is not launched until another application stops and releases its PDP context. When an application is stopped (150, 160, 170), the associated PDP context is released (151, 161, 171). Each application is operated independently, and two applications running at the same time, with the same QoS characteristics, use two dedicated PDP contexts, instead of sharing a common PDP context. This behavior (creating a different PDP context for all the applications running in parallel on a mobile device) is extreme, and is mentioned for illustration purposes. However, it illustrates a model of mobile device with a non-optimized management of the PDP contexts.

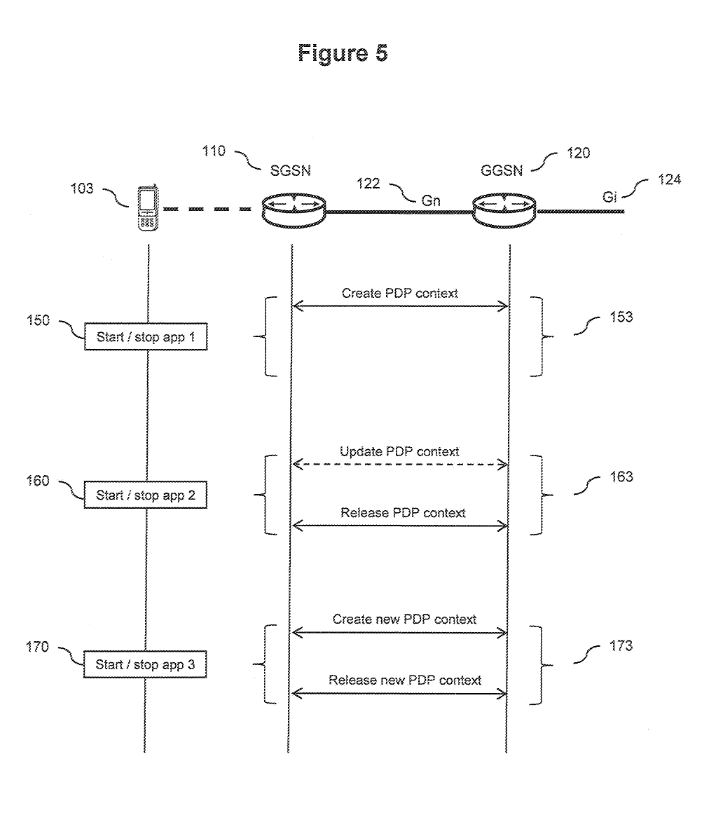

Within the multi task category, other models of mobile devices may reuse (when applicable) an existing PDP context at an application launch. This behavior is illustrated in FIG. 5. We consider three applications running in parallel on the mobile device 103. When the first application is started 150, a PDP context is created 153. When the second application is started 160, the PDP context is updated 163, so that the first and second application both use this PDP context (the QoS characteristics of the PDP context are modified to accommodate both application needs). The PDP context update 163 may even be avoided, in case the first and second applications have similar QoS needs. When the third application is started 170, a new PDP context is created 173. The hypothesis is that this third application 170 has operating conditions too different from the first two applications (150 and 160), and is not able to leverage their existing PDP context. Thus, a new dedicated PDP context is created 173. We consider that the first application stops 150 before the second application 160, so that the associated PDP context is released 163 upon stop of the second application 160. When the third application stops 170, the associated PDP context is released 173.

The behavior of the models of multi task mobile devices described in FIG. 5 is more efficient than the behavior of those described in FIG. 3: the amount of control traffic related to PDP context management is less important, leading to a better network footprint.

Several metrics based on the control traffic generated by PDP context management are calculated, to characterize the network footprint of various models of mobile devices. One metric consists, for a specific model of mobile device, in the ratio between the volume of control traffic related to PDP context management (also referred to as the global control traffic generated by the interactions of the mobile devices with the mobile IP network infrastructure), and the volume of user traffic for the corresponding user traffic (also referred to as the global user traffic, including all types of applications and mobile IP services). The volume of control traffic is the volume of IP traffic exchanged via the GTP control plane (related to PDP context management), between the SGSN 110 and the GGSN 120. The volume of user traffic is the volume of IP traffic exchanged via the GTP user plane (related to the transport of the user data generated by the applications and mobile IP services), between the SGSN 110 and the GGSN 120. The volume of traffic, for both the control traffic and the user traffic, is the cumulative size of all the related GTP IP packets. The size of an IP packet may be calculated, taking into account the Open System Interconnection (OSI) layers 3 to 7 (network, transport, and applicative layers), 4 to 7 (transport and applicative layers), or 5 to 7 (applicative layers only). The metric is calculated over a specific period of time, for a specific model of mobile device, by aggregating the volumes of data for the control traffic and for the user traffic. And then calculating the ratio between the two aggregated volumes. This metric is important, since the control traffic related to PDP context management is typically not charged to the subscribers. Thus, a lower value of the metric indicates a better utilization of the Gn interface, in terms of the proportion of the mobile IP traffic which is charged to the subscriber.

Additionally, the IP traffic generated by the GTP user plane consists in a tunneled IP traffic: the IP packets corresponding to the GTP user plane are transported via a GTP tunnel. This GTP tunnel includes an IP layer, an UDP layer, and a GTP header. The IP packets corresponding directly to the user IP traffic (generated/received by a mobile device) are encapsulated in these GTP tunnel layers (IP, UDP, and GTP header), to be transported over the Gn interface. These GTP tunnel layers may be taken into consideration in various ways for the calculation of the previously mentioned metric. For instance, these GTP tunnel layers may be excluded from the calculation of the volume of user traffic. One rationale for not taking them into consideration is that these GTP tunnel layers are usually not charged to the subscriber. These GTP tunnel layers may also be taken into consideration for the calculation of the volume of control traffic.

Another metric consists, for a specific model of mobile device, in the ratio between the number of control messages related to PDP context management and the volume of the associated user traffic. The number of control messages related to PDP context management is the number of IP messages exchanged via the GTP control plane (related to PDP context management), between the SGSN 110 and the GGSN 120. The volume of user traffic is the volume of IP traffic exchanged via the GTP user plane (related to the transport of the user data generated by the applications and mobile IP services), between the SGSN 110 and the GGSN 120; as defined for the previous metric. The present metric is calculated over a specific period of time, for a specific model of mobile device, by calculating the total number of control messages related to PDP context management, and the aggregated volume of the associated user traffic. And then calculating the ratio between the total number of control messages and the aggregated volume of the associated user traffic. This ratio may be normalized to a pre-defined volume of user traffic: for example, number of control messages per megabyte of associated user traffic. This metric is important too, since each control message requires some processing on the source and destination equipments, implying a consumption of processing resources on the SGSN 110 and the GGSN 120. Thus, a lower value of the metric indicates a better utilization of the SGSN and GGSN resources, in terms of the processing resources dedicated to the control traffic, for the same volume of associated user traffic transferred on the Gn interface 122.

Additional control traffic may be taken into account in the computation of the two metrics described in the previous paragraphs. For example, each creation of a PDP context on the SGSN 110 generates a transaction with a Domain Name Server (DNS) (not represented in the Figures for simplification purposes), to resolve the APN allocated to the PDP context into the IP address of the corresponding GGSN 120. This transaction consists in control traffic between the SGSN 110 and a DNS server, generally on the Gn interface 122. Additionally, a proportion of the control messages related to PDP context management received at the GGSN 120, generate a transaction with a Remote Authentication Dial In User Service (RADIUS) server (not represented in the Figures for simplification purposes), for authorization/accounting procedures. This transaction generates control traffic between the GGSN 120 and the RADIUS server, generally on the Gi interface 124.

Another type of control traffic, which may be taken into account for the computation of the metrics, consists in the IP traffic related to over the air mobile devices update. For instance, an update of the operating system of mobile devices is performed over the air: the upgrade is pushed to the appropriate mobile devices by the mobile network Operator, or directly by the operating system manufacturer or by the mobile device manufacturer. This update generates specific IP traffic, which can be identified, and taken into consideration as a control traffic for the computation of the metrics.

Still another type of control traffic, which may be taken into account for the computation of the metrics, consists in the control traffic generated by mobility management between heterogeneous access networks. For instance, specific mobility management protocols may be used, to ensure a seamless mobility between LTE networks, and other kinds of networks (including CDMA, WIMAX, and WIFI network). A specific mobility management client may be implemented on each mobile device, to ensure this type of seamless mobility management. And the IP traffic generated by this specific mobility management client (for instance, a mobile IP client) may be taken into consideration within the control traffic measurement, for the computation of the metrics. The rationale is that the implementation of the specific mobility management client may vary significantly from one model of mobile device to another, leading to a significant difference in terms of related control traffic generation.

Alternatively, a metric representative of the network footprint of various models of mobile devices is calculated for a specific type of application (or mobile IP service). For this purpose, all the IP packets related to this specific application (or mobile IP service) are monitored on the Gn interface between the SGSN and the GGSN (alternatively, the IP packets related to this application (or mobile IP service) are monitored on the Gi interface of the GGSN). The monitored IP packets are classified into two categories: IP packets corresponding to control traffic and IP packets corresponding to user traffic. This classification depends on the specific type of application (or mobile IP service) considered. The control traffic and the user traffic may be transported via two different protocols, making the differentiation straightforward. Alternatively, if the same protocol is used to transport the control traffic and the user traffic, specific patterns in the IP packets are used to differentiate the control traffic from the user traffic (DPI technology is generally used for this purpose). The behavior of various models of mobile devices may vary significantly, when comparing the amount of control traffic versus user traffic generated for the application (or mobile IP service) considered. For instance, the operating system of a model of mobile device, and/or a specific implementation of the considered application for a specific model of mobile device, may have a major impact on this behavior.

One example of applications with slightly different behaviors consists in mobile messaging applications. The user traffic is defined as the IP packets directly involved in the reception or sending of messages (e.g. emails). The control traffic is defined as the IP packets exchanged between a messaging client on the mobile device, and a messaging server, for synchronization purposes. The synchronization may rely on a polling mechanism, where the messaging client interacts at regular intervals with the messaging server, to detect the availability of new messages (e.g. emails). This mechanism is very intensive in terms of control traffic. Alternatively, the synchronization may rely on a push mechanism, where the messaging server notifies the messaging client when (and only when) a new message (e.g. email) is available. This mechanism is more efficient in terms of control traffic.

Given the definitions of control traffic and user traffic for a mobile messaging application, the two metrics, which have been defined in the previous example related to the control and user planes of the GTP protocol, are applicable to mobile messaging applications (ratio of the volume of the control traffic versus the volume of the user traffic, ratio of the number of control messages versus the volume of the user traffic). The volumes of traffic for both the control traffic and the user traffic are calculated for the mobile messaging application only. Additionally, metrics adapted specifically to mobile messaging may be defined (for example, the volume of control traffic or the number of control messages per email received). These metrics may be used to illustrate the fact that mobile devices using a push mechanism have a better network footprint, when compared with mobile devices using a poll mechanism.

The previous example related to messaging applications may be generalized to any type of application, where a client application on the mobile device interacts with a centralized server, for data synchronization purposes. The synchronization mechanisms generate control traffic, and the amount of control traffic varies significantly, depending on the specific implementation of the synchronization mechanisms. In particular, mobile social networking applications have a growing importance, and rely heavily on data synchronization mechanisms. Metrics related to the network footprint may be used, to compare the implementation of the same mobile social networking client on various models of mobile devices, or to compare different brands of mobile social networking platforms with similar functionalities.

It may be argued that in the case of mobile IP traffic directly related to an application (or mobile IP service), both control traffic and user traffic are charged by the mobile network Operator, making it less relevant to determine the network footprint of a specific application (or mobile IP service). However, the tendency for mobile network Operators is to implement differentiated charging policies, where premium applications are more heavily charged, with for instance a guaranteed Quality of Service in exchange. In this context, a premium application with a bad network footprint is not an issue for the mobile network Operator (in terms of revenues generated). But a non premium application with a bad network footprint is an important issue, since it generates more control traffic, which cannot be charged at a premium rate. Thus, the network footprint of various non premium applications on various models of mobile devices may be used by the mobile network Operator, to determine which models of mobile devices are selected to operate on its mobile network.

As demonstrated with the previous examples, the definitions of the control traffic and the user traffic to be taken into consideration is specific for each metric. Thus, the information extracted by the collecting entities 50 in FIG. 1 shall support each definition, and the appropriate measures for each definition shall be present in the records transmitted to the analytic system 60. For example, for a metric calculated for a specific type of application (e.g. a mobile messaging application), the mobile IP traffic generated by this application is split between the user traffic and the control traffic. However, for a metric taking into consideration the global control traffic (interactions of the mobile devices with the mobile IP network infrastructure) and the global user traffic (including all types of applications and mobile IP services), the same mobile IP traffic generated by this specific application (e.g. a mobile messaging application) is considered as user traffic only.

Now referring concurrently to FIGS. 1 and 6, a report representing a network footprint index for several models of mobile devices will be described.

A report is generated, following an interaction of an end user (e.g. a staff member of the mobile network Operator) with the reports unit 66. The end user selects a report among those available in the reports unit 66, and specifies the parameters associated to this report. The report consists in one or several metrics representative of a network footprint index. The requested metrics, and the associated parameters, are transmitted to the processing unit 62. Examples of such metrics have been detailed in the previous paragraphs. The parameters consist in a list of models of mobile devices for which the metrics are calculated, and a period of time over which the metrics are calculated.

The processing unit 62 queries the database 64, to extract aggregated measures related to the requested metrics, for the specified models of mobile devices, over the specified period of time. Then, the processing unit 62 performs the calculations over the extracted aggregated measures, to compute the values of the metrics. These values are transmitted to the reports unit 66, and displayed to the end user via a Graphical User Interface, using the most appropriate format (column, line, bar, pie charts, etc).

Now focusing on the report displayed in FIG. 6, a column chart is represented to illustrate a particular network footprint index. On the horizontal axis, several models of mobile devices 200 are represented. In the current example, three models 202, 204, and 206 are represented. On the vertical axis, the values of the metrics representative of the network footprint index 210 are represented. Two metrics compose the represented index 210. First, the ratio of control traffic versus user traffic expressed in volumes of data 250. Then, the number of control messages per megabyte of user traffic 260.

For the report represented in FIG. 6, the data transmitted by the report units 66 to the processing unit 62 to request the calculation of the metrics representative of the network footprint index are: the type of metrics to compute 250 and 260; the models of mobile devices for which they are computed 202, 204, and 206; and the period of time over which the calculation is performed (not represented in FIG. 6).

For illustration purposes, FIG. 6 represents an heterogeneity in the network footprint index for the three selected models of mobile devices. The first model 202 has a bad network footprint for both metrics 250 and 252. The second model 204 has a good network footprint in relation to metric 250, and a bad network footprint in relation to metric 260. The third model 206 has a good network footprint for both metrics 250 and 260.

Generally speaking, a bad network footprint is characterized by a propensity, for a specific model of mobile device, to generate a larger amount of control traffic for the same amount of user traffic, when compared to other models of mobile devices. It is measured via different metrics, as illustrated in FIG. 6: a volume of control traffic for metric 250 and a number of control messages for metric 260. Each metric has a different impact on the mobile IP network infrastructure, which may be considered as more or less relevant by different mobile network Operators. For instance, the metric 250 is important in a mobile network where the IP core network is congested (for example, the Gn interface 122, as illustrated in FIG. 3 for an UMTS network), since the excess of control traffic consumes additional bandwidth, which is no longer available for user traffic. The final impact may be a loss of revenue for the mobile network Operator and/or a potential increase of the costs of the infrastructure of the mobile network Operator, due to a necessary upgrade of the networking equipments to increase the available bandwidth. Alternatively, the metric 260 is important in a mobile network where the processing capacity of networking equipments is reaching its limits (for example, the SGSN 110 and GGSN 120, as illustrated in FIG. 3 for an UMTS network), since the excess of control messages consumes additional processing capacity on the networking equipments, which is no longer available to handle user traffic. The final impact may be an increase in the costs of the infrastructure of the mobile network Operator, due to a necessary upgrade of the networking equipments to increase their processing capacity.

Although the present method and system have been described in the foregoing specification by means of several non-restrictive illustrative embodiments, these illustrative embodiments can be modified at will without departing from the scope of the following claims.

1. A method for generating a mobile device network footprint index, the method comprising:
receiving at an analytic system information related to a network footprint of mobile devices;
aggregating by means of the analytic system said information by models of mobile devices;
processing by means of the analytic system said aggregated information to calculate at least one metric representative of a network footprint of a selected model of mobile device over a selected period of time.

2. The method of claim 1, wherein a mobile device network footprint index is generated by means of the analytic system, by calculating the at least one metric for several selected models of mobile devices over the selected period of time.

3. The method of claim 1, wherein the information related to a network footprint of mobile devices consists in records representative of mobile IP sessions occurring on a mobile IP network, said records comprising for each mobile IP session: timestamps of occurrence of the mobile IP session, an identifier of a mobile device used for the mobile IP session, and at least one measure representative of the network footprint of said mobile device; and said identifier of said mobile device enables an identification of the model of said mobile device.

4. The method of claim 3, wherein aggregating the information by models of mobile devices consists in: calculating an aggregated value of each measure representative of the network footprint for a specific model of mobile device over a specific period of time, taking into consideration for said calculation the records representative of the mobile IP sessions for which the identifier of the mobile device and the timestamps of occurrence correspond to said specific model of mobile device and said specific period of time.

5. The method of claim 4, wherein each measure representative of the network footprint is either a measure representative of an user traffic or a measure representative of a control traffic; and processing the aggregated information to calculate at least one metric representative of a network footprint of a selected model of mobile device over a selected period of time consists in: calculating a metric based on the aggregated value of a measure representative of a user traffic and the aggregated value of a measure representative of a control traffic, wherein both of said aggregated values correspond to said selected model of mobile device and said selected period of time.

6. The method of claim 5, wherein the measure representative of a user traffic is a volume of user traffic and the measure representative of a control traffic is a volume of control traffic, and the metric representative of a network footprint of a selected model of mobile device over a selected period of time consists in a ratio between the aggregated value of said volume of control traffic and the aggregated value of said volume of user traffic, for said selected model of mobile device and said selected period of time.

7. The method of claim 5, wherein the measure representative of a user traffic is a volume of user traffic and the measure representative of a control traffic is a number of control messages, and the metric representative of a network footprint of a selected model of mobile device over a selected period of time consists in a ratio between the aggregated value of said number of control messages and the aggregated value of said volume of user traffic, for said selected model of mobile device and said selected period of time.

8. The method of claims 6 and 7, wherein the measure representative of a user traffic takes into consideration at least one of: the global user traffic, the user traffic generated by a specific type of application or mobile IP service.

9. The method of claims 6 and 7, wherein the measure representative of a control traffic takes into consideration at least one of: the control traffic generated by interactions of the mobile devices with the mobile IP network infrastructure, the control traffic generated by a specific type of application or mobile IP service, or a combination thereof.

10. A system for generating a mobile device network footprint index, the system comprising:
an analytic system:
for receiving information related to a network footprint of mobile devices,
for aggregating said information by models of mobile devices, and
for processing said aggregated information to calculate at least one metric representative of a network footprint of a selected model of mobile device over a selected period of time.

11. The system of claim 10, wherein the analytic system includes a processing unit for aggregating the information and processing the aggregated information, and a database for storing the aggregated information.

12. The system of claim 10, wherein a mobile device network footprint index is generated by means of the analytic system, by calculating the at least one metric for several selected models of mobile devices over the selected period of time.

13. The system of claim 10, wherein at least one collecting entity:
collects data related to mobile IP sessions occurring on a mobile IP network,
extracts from said data information related to a network footprint of mobile devices, and
transmits said information to the analytic system.

14. The system of claim 10, wherein the information related to a network footprint of mobile devices consists in records representative of mobile IP sessions occurring on a mobile IP network, said records comprising for each mobile IP session: timestamps of occurrence of the mobile IP session, an identifier of a mobile device used for the mobile IP session, and at least one measure representative of the network footprint of said mobile device; and said identifier of said mobile device enables an identification of the model of said mobile device.

15. The system of claim 14, wherein aggregating the information by models of mobile devices consists in: calculating an aggregated value of each measure representative of the network footprint for a specific model of mobile device over a specific period of time, taking into consideration for said calculation the records representative of the mobile IP sessions for which the identifier of the mobile device and the timestamps of occurrence correspond to said specific model of mobile device and said specific period of time.

16. The system of claim 15, wherein each measure representative of the network footprint is either a measure representative of an user traffic or a measure representative of a control traffic; and processing the aggregated information to calculate at least one metric representative of a network footprint of a selected model of mobile device over a selected period of time consists in: calculating a metric based on the aggregated value of a measure representative of a user traffic and the aggregated value of a measure representative of a control traffic, wherein both of said aggregated values correspond to said selected model of mobile device and said selected period of time.

17. The system of claim 16, wherein the measure representative of a user traffic is a volume of user traffic and the measure representative of a control traffic is a volume of control traffic, and the metric representative of a network footprint of a selected model of mobile device over a selected period of time consists in a ratio between the aggregated value of said volume of control traffic and the aggregated value of said volume of user traffic, for said selected model of mobile device and said selected period of time.

18. The system of claim 16, wherein the measure representative of a user traffic is a volume of user traffic and the measure representative of a control traffic is a number of control messages, and the metric representative of a network footprint of a selected model of mobile device over a selected period of time consists in a ratio between the aggregated value of said number of control messages and the aggregated value of said volume of user traffic, for said selected model of mobile device and said selected period of time.

19. The system of claims 17 and 18, wherein the measure representative of a user traffic takes into consideration at least one of: the global user traffic, the user traffic generated by a specific type of application or mobile IP service.

20. The system of claims 17 and 18, wherein the measure representative of a control traffic takes into consideration at least one of: the control traffic generated by interactions of the mobile devices with the mobile IP network infrastructure, the control traffic generated by a specific type of application or mobile service, or a combination thereof.
